(19) United States
(12) Patent Application Publication
(10) Pub. No.: US 2015/0336342 A1
(43) Pub. Date: Nov. 26, 2015

(54) Method for Producing Tire-Curing Bladder

(71) Applicant: BRIDGESTONE AMERICAS TIRE OPERATIONS, LLC, Nashville, TN (US)

(72) Inventors: Robert W. Asper, Wadsworth, OH (US); Adam K. Nesbitt, Akron, OH (US); Jason R. Barr, Akron, OH (US); Clinton D. Graham, Butler, PA (US)

(21) Appl. No.: 14/653,080

(22) PCT Filed: Dec. 10, 2013
(86) PCT No.: PCT/US2013/073991

§ 371 Date: Jun. 17, 2015

Related U.S. Application Data
(60) Provisional application No. 61/739,434, filed on Dec. 19, 2012.

(51) Int. Cl. B29D 30/06; B29D 30/08; B29C 35/02

(52) U.S. Cl. CPC B29D 30/0654; B29C 35/02; B29D 30/08; B29D 2030/0659; B29L 2022/025

(57) ABSTRACT

A method for forming and curing an uncured tire-curing bladder with a bladder-curing bladder includes providing an uncured tire-curing bladder having an inner and outer surface on or in a recess of an outer-surface curing mold; inflating the bladder-curing bladder into the recess and exerting pressure on the inner surface of the uncured tire-curing bladder; and curing the uncured tire-curing bladder by providing heat, pressure, or both to the inner surface and the outer surface of the tire-curing bladder to form a cured tire-curing bladder. A thin tire-curing bladder and a curing apparatus are also provided.

### FIELD

A method of manufacturing tire forming bladders is disclosed herein.

### BACKGROUND OF THE ART

Tire curing apparatuses, such as tire presses, typically cure or vulcanize a tire by applying both internal and external heat and pressure. A tire press uses a heated outer metal mold that serves to shape and vulcanize the outside of the tire. This is used in conjunction with a rubber curing bladder that is inflated in the inside of a tire carcass and heated to vulcanize the interior of the tire.

Due to the mechanical strain that tire-curing bladders are subjected to and the special function they are called upon to perform, tire-curing bladders are typically required to be of a custom size and dimension to meet the requirements of each different tire design. Forming a tire-curing bladder may require a custom-made mold that is expensive and time-consuming to produce. Alternatively, tire-curing bladders can also be hand-made and cured in an autoclave using a relatively time-consuming, high-cost manufacturing process.

### SUMMARY

A method for forming and curing an uncured tire-curing bladder with a bladder-curing bladder includes providing an uncured tire-curing bladder having an inner and outer surface on or in a recess of an outer-surface curing mold; inflating the bladder-curing bladder into the recess and exerting pressure on the inner surface of the uncured tire-curing bladder; and curing the uncured tire-curing bladder by providing heat, pressure, or both to the inner surface and the outer surface of the tire-curing bladder to form a cured tire-curing bladder.

A thin tire-curing bladder includes an organic rubber layer and excludes a silicone rubber layer. In an embodiment a tire-curing bladder has a thickness of about 1 mm to less than 2.5 mm.

A curing apparatus includes a press operable to heat an outer surface mold; an outer surface mold coupled to the press comprising a plurality of rings defining a recess; a first foot area recess defined in one or more rings configured to receive a foot area of a tire-curing bladder; and a second foot area recess defined in one or more rings configured to receive a foot area of a bladder-curing bladder.

As used herein the terms “a” and “the” mean one or more, unless the context clearly indicates to the contrary.

The terms “cure” and “vulcanize” are used interchangeably herein. While the disclosure is focused on sulfur curing (vulcanization) where sulfidic bridges crosslink polymer chains, the technology disclosed herein is also applicable to other types of curing.

The term “tire” or “tires,” as used herein, includes, for example, both pneumatic radial tires as well as pneumatic bias ply tires.

### BRIEF DESCRIPTION OF THE DRAWING FIGURES

FIG. 1 is a partial cross-section of a prior art transfer molding apparatus for forming a tire-curing bladder.

FIG. 2 is diagram of an embodiment of processes for making and curing a tire-curing bladder 132 and tire.

FIG. 3 is a diagram of an embodiment of a process for assembling a tire-curing bladder 132 on a drum.

FIG. 4A is a partial cross-sectional view of an embodiment of the tire-curing bladder 132 of FIG. 3.

FIG. 4B is a partial cross-section of an embodiment of the tire-curing bladder 132 of FIG. 3 and a process for curing a the tire-curing bladder 132 with a bladder-curing bladder 136.

FIG. 5 is a partial cross-sectional view of a tire-curing mold apparatus 402 where an embodiment of a tire-curing bladder 406 is placed inside a green tire 404 and set in a recess of the tire-curing mold 409.

FIG. 6 is a partial cross-sectional view of a modified tire-curing mold apparatus 403 with an embodiment of a bladder-curing bladder 136 set within a tire-curing bladder 132 that is inside a recess 409 of the tire-curing mold.

FIG. 7A is a cross-sectional view of a bladder curing mold 702 with an embodiment of a bladder-curing bladder 136 set within a tire-curing bladder 132.

FIG. 7B is a cross-sectional view of a pre-assembled bladder curing mold 702 with an embodiment of a bladder-curing bladder 136 set within a tire-curing bladder 132.

### DETAILED DESCRIPTION

Surprisingly, in contrast to the prior art methods of transfer or injection molding that required custom molds, a suitably customized tire-curing bladder can be cured in a tire-building mold itself or a mold that is configured to fit in a tire press, thereby achieving both tire build time reduction and cost reduction. For example, an outer-surface curing mold for a tire-curing bladder may be configured for compatibility with a tire-curing press. The outer-surface curing mold may be coupled to a container that is itself dimensioned to fit into a tire-curing press.

The tire press for which the customized tire-curing bladder is designed for use may be used to cure the outside of the tire-curing bladder, while the inside of the tire-curing bladder is cured with a separate bladder-curing bladder. The outer-surface curing mold for forming the tire-curing bladder may be of dimensions similar to what the dimensions are for a tire curing mold it is designed for use in. Time and costs may be reduced by using a generically-sized, bladder-curing bladder to cure a tire-curing bladder and provide the tire-curing bladder with customized dimensions that are adapted to the same or similar sized tire for which the tire-curing bladder is to be used to cure.

In an embodiment, a blank tire mold that corresponds to the dimensions of a tire mold, except it is smaller in the axial and bead-to-bead dimensions, may be used as the outer-surface curing mold for the tire-curing bladder.

In an embodiment, the method of curing the tire-curing bladder with a bladder-curing bladder is complementary to building the pre-cured tire-curing bladder on a drum. This allows for versatility in adding reinforcing layers and changing thicknesses.

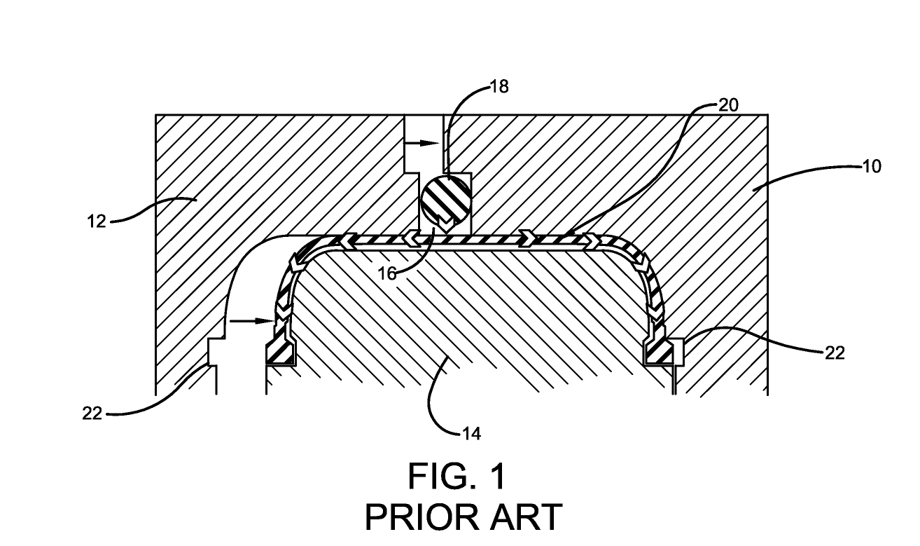

FIG. 1 depicts a prior art transfer mold for making a tire-curing bladder. This prior art method of making a curing bladder requires a three-part metal mold that includes a first-half outer mold 10, a second-half outer mold 12, and a rigid inside mold 14. A rubber blank 18 is forced out of the compartment 16 and disposed in the interface between the first- and second-half outer molds 10, 12. In operation, a rubber blank 18 is placed in the compartment 16 and heat and pressure is applied to force the rubber to melt and flow into the mold area 20 which is defined by the surfaces of the first-half outer mold 10, second-half outer mold 12, and the rigid inside mold 14.

Injection and transfer molds are expensive and time-consuming to produce. The metal mold pieces must be specially made for each different curing bladder size and shape required by the tire maker. Conventionally, it was also expected that each tire with different shape and/or dimensions required a custom-built tire-curing bladder to meet those dimensions. Furthermore, due to the high rubber flow required by the transfer mold method to flow the rubber into the foot area 22 of the tire-curing bladder there was a lower limit on the gauge of the bladder that could be formed. Bladders formed by this conventional method could effectively only reach a minimum thickness of about 4.5 mm. A bladder of such thickness has limited heat transfer capabilities, which in turn limits its efficiency in curing the inner portion of a tire. In addition, the high rubber flow also produces large deformations, which reduces the quality and durability of the bladder.

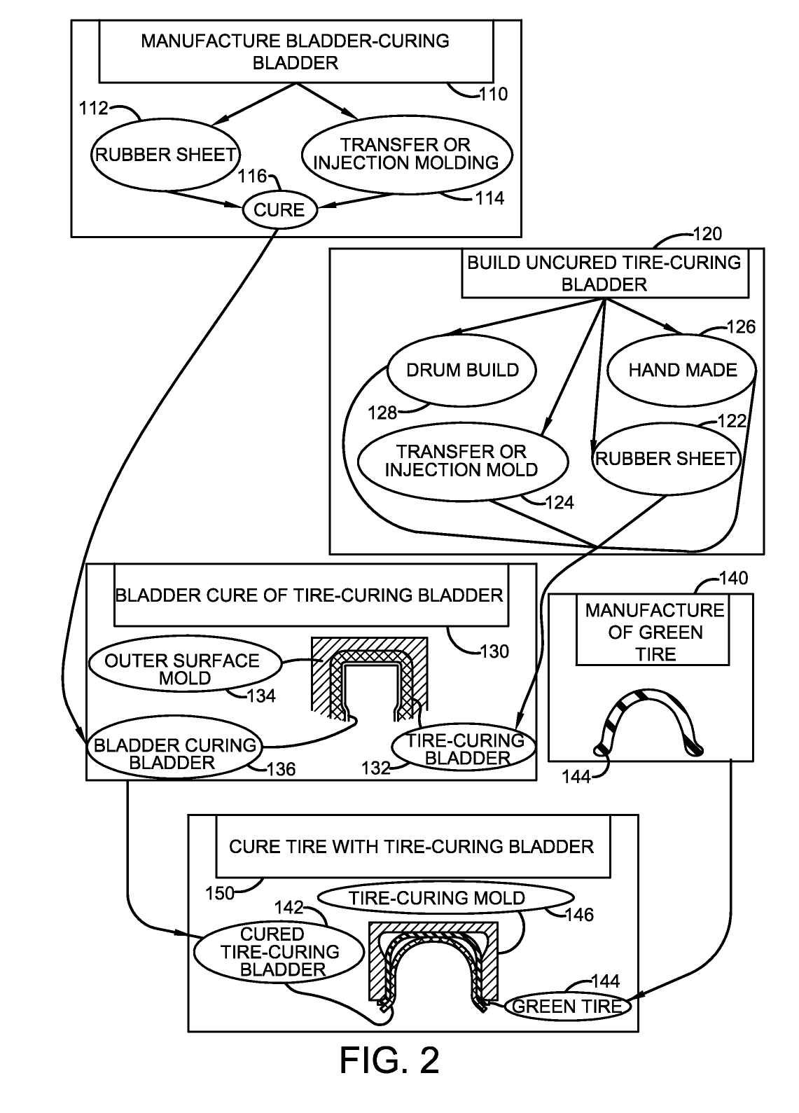

FIG. 2 depicts an overview of the processes disclosed herein wherein a tire-curing bladder 132 is cured by a bladder-curing bladder 136.

A step of manufacturing the bladder-curing bladder 110 is depicted in FIG. 2. In the example step 110, a bladder-curing bladder 136 as disclosed herein may be manufactured quickly and inexpensively without the need for a precise size and shape. A general-sized bladder-curing bladder 136 can be formed by conventional techniques and be useful for curing numerous sizes and shapes of tire-curing bladders. Contrary to the prior art techniques of bladder curing of tires, a one-size-fits-many approach may be effectively used to bladder cure a tire-curing bladder.

The bladder-curing bladder 136 may be manufactured by cost-efficient techniques, such as extruding or calendaring a rubber sheet 112 or by injection or transfer molding 114. A conventional curing process may be used 116. Because a single-sized and dimensioned bladder-curing bladder 136 can be used for curing many different dimensioned tire-curing bladders, time and cost efficiencies are gained by this method. Other processes to cure the bladder-curing bladder 136 may be used as well, including curing the bladder-curing bladder 136 in a tire mold, such as the same tire mold used in the tire-curing bladder cure process 130.

A bladder-curing bladder 136 may have a geometry and composition similar to that of a conventional tire-curing bladder. A foot area of the bladder-curing bladder 136 may be provided with additional thickness in comparison to the center portion of the bladder-curing bladder 136. In an embodiment, the bladder-curing bladder 136 comprises a single or double-foot shape in the foot area according to the configuration of the mold it is designed to be used with.

FIG. 2 also depicts a step of building the uncured tire-curing bladder 120. In an embodiment, various methods may be used to form the uncured tire-curing bladder 120, including, for example, rubber sheet extrusion or calendaring 122, transfer or injection molding 124, and hand-assembly 126. In an embodiment, drum building techniques 128 are used to build a tire-curing bladder.

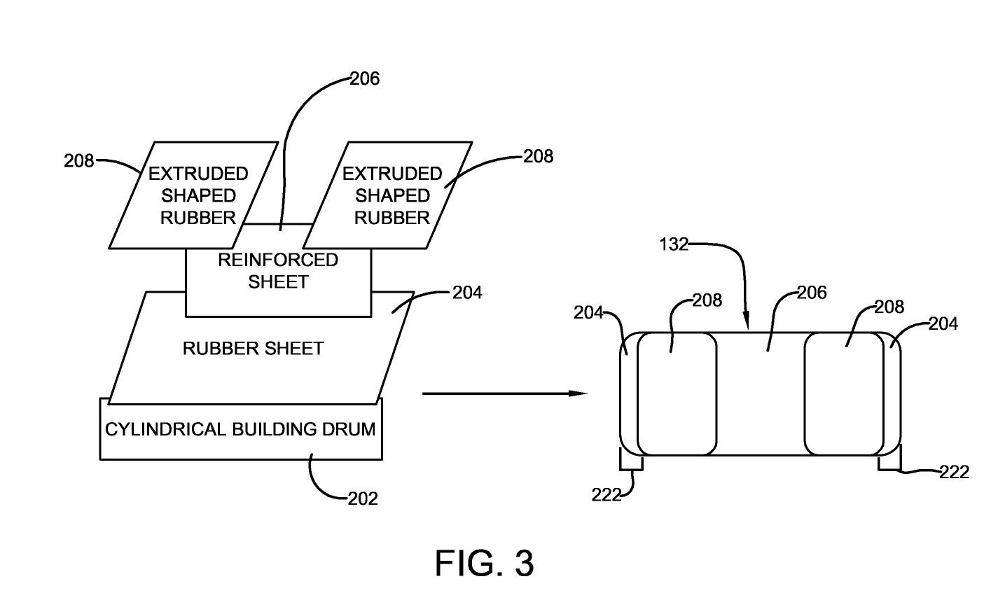

For further information on the drum building technique 128, reference is made to FIG. 3. In an embodiment, a hollow cylindrical drum 202 is provided, upon which an uncured rubber sheet 204 is wrapped. In other embodiments the drum is not required to be hollow or cylindrical. In an embodiment, the ends of the rubber sheet 204 may extend to reach around the cylindrical drum 202 to overlap or abut. The drum 202 functions to provide a basic ring or partial toroidal shape to the uncured tire-curing bladder 132. The uncured rubber sheet 204 may, for example, be extruded or calendered.

In an embodiment, a reinforced sheet 206 that includes woven fiber or other reinforcing materials is applied onto the rubber sheet 204 on the cylindrical drum 202. These reinforcements include corded sheets or strips of material. The cords are embedded in the reinforced sheet 206. The reinforcement material may be selected from materials used for body ply or belt materials of a tire. Reinforcements are added to control the inflated shape of the tire-curing bladder when it is used to cure a tire.

In an embodiment, an additional layer or layers 208 may also be applied for shaping or reinforcing the 132 tire-curing bladder. In an embodiment, additional layer sheets, may be used to urge the tire-curing bladder into a partial toroidal shape with sides, rather than just a flattened ring. The foot area 222 of the tire-curing bladder 132 may be provided with additional thickness in comparison to the center portion of the tire-curing bladder 132. In an embodiment, the tire-curing bladder 132 comprises a single or double-foot shape in the foot area 222 according to the configuration of the tire-curing mold it is designed to be used with.

The additional layer 208 in this embodiment is comprised of a calendered or extruded rubber shape. In an embodiment, the rubber sheet 204 is a flat component with a single thickness. The additional layer 208 has a shape, meaning that the thickness of this component varies along the width.

The drum building process 128 allows the creation of a tire-curing bladder 132 that is very thin, and not subject to the limitations of injection and transfer molding processes 124. Use of the drum building process 128 in conjunction with the gentle bladder curing process allows for exceptionally thin bladders having a gauge of less than 2.5 mm, including, for example, from about 2 mm to about 1 mm, about 1.75 mm to about 0.75 mm, or about 1.25 mm to about 1.1 mm. These thicknesses may be measured at the center of the tire-curing bladder. This disclosure should not be construed to limit the method for making the bladder at higher thicknesses, such as up to 4.5 mm or 8 mm.

In an embodiment, the thickness of the tire-curing bladder 132 is thinnest at the center and thickest at the foot area 222. In an embodiment, the tire-curing bladder 132 is of approximately uniform thickness from shoulder-to-shoulder or from foot-to-foot. The drum building process 128 also allows for a customized inflated shape, customized reinforcement, and variable stiffness.

Referring again to FIG. 2, a bladder curing process 130 is depicted for curing the uncured tire-curing bladder 132 that is manufactured in the previously discussed tire-curing bladder building step 120. In the bladder curing process 130, the uncured tire-curing bladder 132, is cured by an outer surface mold 134 and a bladder-curing bladder 136 manufactured in the previously discussed bladder-curing bladder manufacturing step 110.

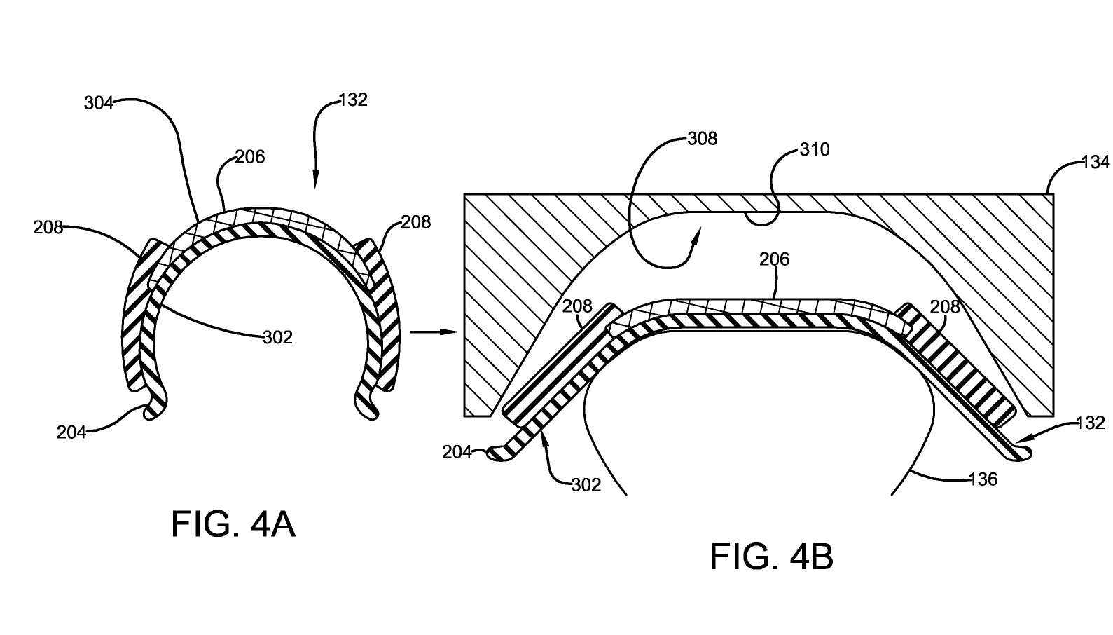

Reference is made to FIGS. 4A and 4B for further details of the bladder curing process 130. FIG. 4A shows a partial cross-sectional view of the embodiment of the uncured tire-curing bladder 132 originally shown in FIG. 3. FIG. 4A shows a partial cross-sectional view of the uncured tire-curing bladder 132 removed from the hollow cylinder 202. This uncured tire-curing bladder 132 has an inner surface 302 and an outer surface 304.

As shown in FIG. 4B the uncured tire-curing bladder 132 is provided on or in a recess 308 of an outer-surface curing mold 134. In an embodiment, a foot area of the tire-curing bladder 132 may be secured at an edge of the recess of the outer-surface curing mold 134. Once properly positioned, the bladder-curing bladder 136 is inflated into the recess 308 thereby exerting pressure on the inner surface 302 of the uncured tire-curing bladder 132. The source of inflation may be, for example, a conventional tire press apparatus. The pressure exerted by the inflation of the bladder-curing bladder 136 causes the tire-curing bladder 132 to move into the recess 308, and into contact with the curing surface 310 of the outer-surface curing mold 134.

Heat is applied to the outer-surface curing mold 134 and the inflated bladder-curing bladder 132. This heat, for example, may be applied by a conventional tire press apparatus. The uncured tire-curing bladder 132 is thus cured by receiving the heat transferred from the outer-surface curing mold 134 and the inflated bladder-curing bladder 136, as well as the pressure caused from the inflation of the bladder-curing bladder 136.

The bladder-curing bladder 136 may be inflated and heated by a heated fluid, such as, for example, by a mixture of water, steam, and/or nitrogen gas heated to a temperature of, for example, about 160° C. to about 210° C., or through other means known by those of skill in the art of tire vulcanization. The outer-surface curing mold 134 may also be heated by means known to those of skill in the art of tire vulcanization.

In an embodiment, the tire-curing bladder cure process 130 incorporates an outer-surface curing mold 134 that is used for vulcanizing a green tire, which may be a blank unpatterned mold, such as those used for racing slicks or a patterned mold for producing passenger tires with tread patterns.

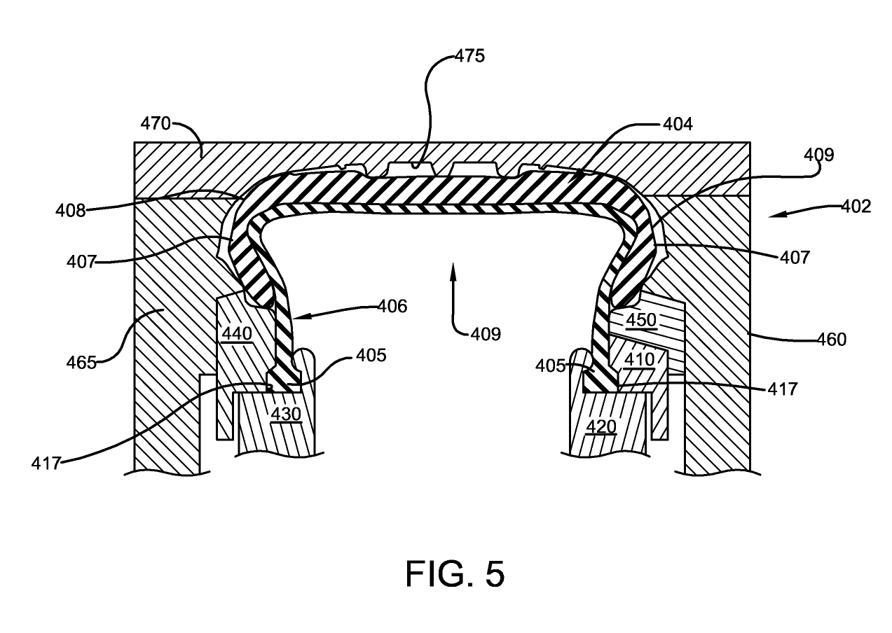

FIG. 5 shows a partial cross-section of an example tire-curing mold 402. The tire-curing mold 402 includes several ring-shaped plates that are combined to hold the green tire 404 in place. Rings 410, 420, 430, 440, and 450 function to grip the enlarged foot area 405 (in this case a double-sided foot) of the tire-curing bladder 406 in a foot area recess 417 of the tire-curing mold 402. The top side plate 460 and bottom side plate 465 function to enclose and support the sidewall 407 and shoulder portions 408, 409 of the green tire 404. The tread ring 470 mounts along the outer circumference of the tire curing mold 402 and has an inner surface 475 with protrusions and/or grooves. The tread ring 470 functions to impart a tread pattern in the outer circumference of the green tire 404. The rings and plates described above define the recess 409 of the tire curing mold 402.

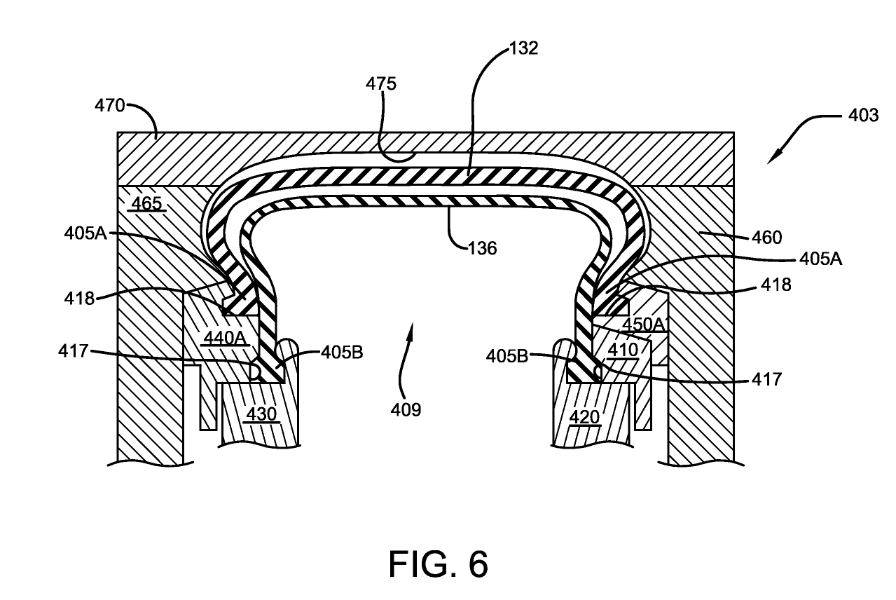

In an embodiment, as shown in FIG. 6, a modified tire-curing mold 403 can be used to cure the tire-curing bladder 132 instead of a green tire. The modified tire curing mold 403 has been modified to replace tread pattern geometry on the inner surface 475 of the tread ring 470, sidewall stamping, and traditional bead ring contour with a smooth or textured surface and a single sided foot recess 418 formed by modified rings 440A, 450A for attaching the tire-curing bladder 132.

In FIG. 6 an embodiment of a bladder-curing bladder 136 is provided in the recess 409 of the modified tire-curing mold 403, and the tire-curing bladder 132 is provided between the bladder-curing bladder 136 and the inner surface of the modified tire-curing mold 403.

In the embodiment of FIG. 6, the tire-curing bladder 132 has a single-sided foot 405A that is held in the foot recess area 418 of rings 440A and 450A. A double-sided foot 405B of the bladder-curing bladder 136 is held in the foot area recess 417 of the modified tire-curing mold 403.

In an alternative embodiment, the bladder-curing bladder 136 and the tire-curing bladder 132 are both secured in the foot area recess 417 of the unmodified tire mold 402 of FIG. 5. In another embodiment, the bladder-curing bladder 136 may be secured by other means, while the tire-curing bladder has a double foot that is held in the foot area recess 417.

In each of these embodiments, the tire-curing mold 402 or modified tire-curing mold 403 used for curing the tire-curing bladder 132 may be of the same or similar dimensions as a tire-curing mold 402 that is used for vulcanizing a green tire 404 with the cured tire-curing bladder 142, except it is smaller in one or more of the axial and bead-to-bead dimensions.

In an embodiment, the outer-surface curing mold 134 is a mold used for curing blank tires. A blank tire, as referred to herein, is a tire without any tread pattern. A blank tire mold, for example, may be used for vulcanization of racing slicks. In this embodiment, the tire curing mold is the same or substantially the same as depicted in FIGS. 5 and 6, except the tread ring 470 has a smooth inner-surface 475 with no tread pattern. However in this embodiment, and even in tire blanks, the inner surface 475 of the tread ring 470 may be imparted with small grooves for circulating air to aid in removal of the cured tire-curing bladder 142 from the blank tire curing mold. In addition, a mold-release coating composition may be present on the uncured tire-curing bladder 132, the bladder-curing bladder 136, or both.

Just as in the tire vulcanization process, the tire-curing bladder 132 is cured by heat being transferred from a tire press to each of the plates and rings of the tire-curing mold 402 to vulcanize from the outer surface of the tire-curing bladder 132, and the bladder-curing bladder 136 is inflated with a heated fluid, such as water, steam and/or nitrogen gas to vulcanize from the inner surface of the tire-curing bladder 132.

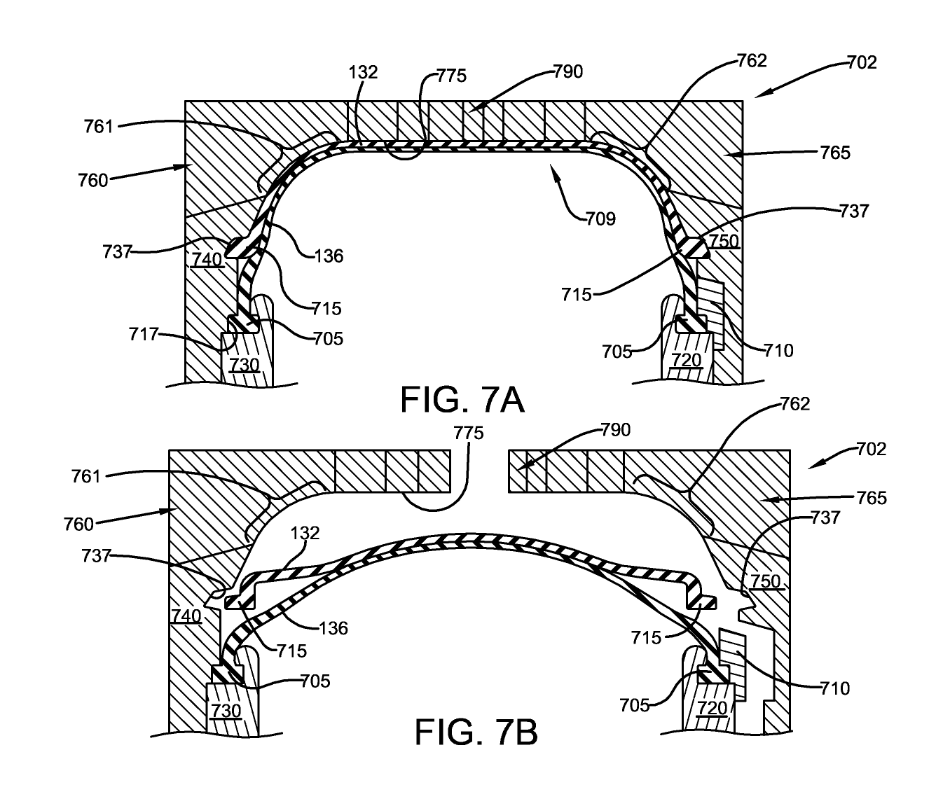

Alternatively, as shown in FIGS. 7A and 7B, in another embodiment, a dedicated bladder-curing tailored mold 702 may be used for curing the tire-curing bladder 132. FIG. 7A shows the tailored mold 702 assembled with the tire-curing bladder 132 and bladder-curing bladder 136 in place, while FIG. 7B shows the pre-assembled view.

In the embodiment of FIGS. 7A and 7B, an additional foot area recess 737 is provided to anchor the tire-curing bladder 132, while the bladder-curing bladder 136 is gripped by a foot area recess 717 that is substantially the same as the embodiment of FIG. 6. In addition, the tailored mold 702 includes stackable ring segments 790 that allow the tailored mold 702 to be adjusted to accommodate a range of axial (bead-to-bead) widths. The tailored mold 702 may have the same dimensions or approximately the same dimensions of a tire-curing mold that is used for vulcanizing a green tire with the cured tire-curing bladder 142. In an embodiment, the tailored mold 702 is smaller in one or more of the axial and bead-to-bead dimensions than a tire-curing mold that tire-curing bladder 132 is to be used with.

Like the tire-curing mold 402 of FIGS. 5 and 6, the tailored mold 702 includes several ring-shaped plates that are combined to hold the bladders 132, 136 in place. Rings 710, 720, 730, 740, function to grip the foot area 705 (in this case a double-sided foot) of the bladder-curing bladder 136 in a foot area recess 717 of the tailored mold 702. Rings 740 and 750 include a recess 737 that functions to anchor the foot area 715 (in this case a single-sided foot) of the tire-curing bladder 132. In this example, the inflated bladder-curing bladder 136 will contact the inner side of the foot area 715 of the tire-curing bladder 132. The tailored mold 702 allows for rings 710, 720, 730, 740, and 750 to be adjusted to accommodate a range of recessed foot diameters.

Shoulder rings 765, 760 function to enclose and support shoulder portions 760, 761 of the tire-curing bladder 132 in the tailored mold 702. The stackable ring segment(s) 790 mount along the outer circumference of the tailored mold 702 and have an inner surface 775 that is predominantly smooth, but in an embodiment may be provided with air circulation channels. The rings described above define the recess 709 of the tailored mold 702.

As shown by comparing FIGS. 7A and 7B the bladder-curing bladder 136 and tire-curing bladder 132 may be loaded into the tailored mold 702 and then enclosed in the tailored mold 702 by moving the rings on the right side of FIGS. 7A and 7B 710, 750, together in the axial direction along with the right shoulder ring 765. Stackable rings 790 can also be moved axially.

One or more bladder-curing bladders 136 of the same size can be used to create various different sized tire-curing bladders 132. The dimensions of the bladder-curing bladder 136 and the tire-curing bladder 132 that it (the bladder-curing bladder 136) is utilized to cure may vary up to 40% in the axial (bead-to-bead) dimension or radial dimension, or both, such as, for example, about 0.5% to about 40%, about 1% to about 15%, or about 5% to about 10%. However, the bladder-curing bladder 136 is smaller than the tire-curing bladder 132. This feature allows for versatility and alleviates the need for a specialized bladder for each tire size. In an embodiment the bladder-curing bladder 136 stretches 5-40% to cure the tire-curing bladder 132.

Returning to FIG. 2, once the tire-curing bladder 132 is cured, and a green tire 144 is manufactured 140 (Pneumatic tires can, for example, be made according to the constructions disclosed in U.S. Pat. Nos. 5,866,171; 5,876,527; 5,931,211; and 5,971,046, the disclosures of which are incorporated herein by reference), the cured tire-curing bladder 142 is placed on or inside the green tire 144, which is set in a tire curing mold 146, such as the one depicted in FIG. 5. The green tire 144 is cured by imparting a fluid at high temperature and pressure to the inside of the cured tire-curing bladder 142 and heat to the metal plates of the tire-curing mold 146. The cured tire-curing bladder 142 thereby expands to press the green tire 144 against the inner surface of the tire-curing mold 146. With a non-blank tire mold a tread pattern is impressed in the outer circumferential surface of the green tire 144 and the green tire 144 is vulcanized. In an embodiment, the heat and pressure may be supplied as a mixture of water, steam, and/or nitrogen gas heated to a temperature of, for example, about 160° C. to about 210° C.

In an embodiment of the above-described process, a custom-sized tire can be created more quickly and cheaply because a relatively custom-sized bladder to match it can be quickly created without the need for an expensive custom-made transfer or injection bladder mold. The tailored mold 702 can be used to create a cured tire-curing bladder 142 quickly using a general sized bladder-curing bladder, without the need to create a custom injection or transfer mold with rigid inner and outer surfaces for curing the tire-curing bladder shape.

In either of the above embodiments, the tire-curing bladder 132 need not be exactly dimensioned to match the interior of the green tire 144 to be effective, and may vary up to 40% in either the axial (bead-to-bead) dimension or the radial dimension, or both, such as, for example, about 0.5% to about 30%, about 1% to about 15%, or about 5% to about 10%, so long as the dimensions of the tire-curing bladder 132 is smaller than the interior of the green tire 144.

In an embodiment, a green tire 144 is cured with the cured tire-curing bladder 132 and a tire-curing mold 146. The tire-curing mold 146 has cross-sectional axial and radial dimensions of X and Y. The outer surface mold 134 that was used to cure the tire-curing bladder 132 has cross-sectional axial and radial dimensions of 0.6X to X and 0.6Y to Y.

In an embodiment, the bladder-curing bladder 136 has a cross-sectional axial and radial dimensions of 0.6X to X and 0.6Y to Y, wherein X and Y are the cross-sectional axial and radial dimensions of the interior of the outer surface mold 134 used to cure the tire-curing bladder 132.

In an embodiment, a first uncured tire-curing bladder 132 may be cured with a bladder-curing bladder 136. A subsequent uncured tire-curing bladder with at least one different dimension that varies from about 0.5% to about 40% of the first uncured tire-curing 132 bladder may also be cured with the same bladder-curing bladder 136, so long as it is smaller in its dimensions than the subsequent uncured tire-curing bladder.

In an embodiment, the outer mold used in making the tire-curing bladder and the green tire may be a low-profile tire, such as a tire with a section height less than 100 mm. Conventional curing of low profile tires presents a special challenge due to their acutely angled dimensions in the shoulder area of the tire. By using a bladder-curing bladder 136 to cure the tire-curing bladder 132 in the same mold as the low profile tire or a mold of similar dimensions but smaller in the bead-to-bead and/or axial dimension, the tire-curing bladder 132 can acquire a customized dimension that will enhance its ability to inflate into acute angles and cure the low profile tire.

In an embodiment, one or more rubber elastomers are used for the tire-curing bladder 132 and bladder-curing bladder 136. In an embodiment, the bladders 132, 136 comprise one or more organic elastomers, such as carbon-backbone-based elastomers, rather than silicone-based elastomers. For example, the organic elastomer may be selected from the following, individually as well as in combination, according to the desired final properties of the rubber compound: a butyl rubber, a halobutyl rubber, a modified butyl rubber, an ethylene propylene rubber, an ethylene propylene diene rubber (EPDM), a nitrile butadiene rubber, a hydrogenated nitrile butadiene rubber, a styrene butadiene rubber, a chloroprene rubber, an isoprene rubber, an epichlorohydrin rubber, an acrylic rubber, a chlorosulfonated polyethylene, and a fluorocarbon rubber. In an embodiment, the composition is exclusive of ethylene-propylene-diene-terpolymer, silicone rubber, or both. In another embodiment, silicone rubber may be present. The elastomers may contain a variety of functional groups, including but not limited to tin, silicon, and amine containing functional groups. The rubber polymers may be prepared by emulsion, solution, or bulk polymerization according to known suitable methods.

In an embodiment containing a blend of more than one polymer, the ratios (expressed in terms parts per hundred rubber (phr)) of such polymer blends can be adjusted according to the desired final viscoelastic properties desired for the polymerized rubber compound. For example, in an embodiment natural rubber or polyisoprene may comprise about 5 to about 80 phr, such as about 20 phr to about 60 phr, or about 35 phr to about 55 phr; and butyl or halobutyl rubber may comprise about 60 phr to about 5 phr, such as about 50 phr to about 10 phr, or about 25 phr to about 15 phr. In an embodiment, one of the rubbers above is selected and comprises the entire rubber component.

In an embodiment, the bladders may comprise one or more fillers to provide reinforcement and/or improved air permeability. The filler may be selected from the group consisting of carbon black, silica, various types of clay or mineral fillers. For example, clay and mineral fillers include aluminum silicate, calcium silicate, magnesium silicate, clay (hydrous aluminum silicate), talc (hydrous magnesium silicate), and mica.

The total amount of filler may be from about 1 to about 100 phr, such as from about 30 to about 80 phr, from about 40 to about 70 phr, or from about 50 to about 100 phr of filler.

Additional rubber compounding ingredients may include curing packages, processing aids, coupling agents, and the like. For example, without limitation, the bladders 132, 136 disclosed herein may also contain such additional ingredients in the following amounts:
processing oils/aids: from about 0 to about 75 phr, such as from about 5 to about 40 phr;
stearic acid: from about 0 to about 5 phr, such as from about 0.1 to about 3 phr;
zinc oxide: from about 0 to about 10 phr, such as from about 0.1 to about 5 phr;
sulfur: from about 0 to about 10 phr, such as from about 0.1 to about 4 phr; and
accelerators: from about 0 to about 10 phr, such as from about 0.1 to about 5 phr.

The invention is not limited to only the above embodiments. The claims follow.

What is claimed is:

1-15. (canceled)

16. A method for forming and curing an uncured tire-curing bladder with a bladder-curing bladder, comprising:
providing an uncured tire-curing bladder having an inner and outer surface on or in a recess of an outer-surface curing mold;
inflating the bladder-curing bladder into the recess and exerting pressure on the inner surface of the uncured tire-curing bladder; and
curing the uncured tire-curing bladder by providing heat, pressure, or both to the inner surface and the outer surface of the tire-curing bladder to form a cured tire-curing bladder.

17. The method of claim 16, further comprising securing a foot area of the tire-curing bladder at an edge of the recess of the outer-surface curing mold.

18. The method of claim 16, wherein the steps of claim 1 are repeated with a subsequent uncured tire-curing bladder with at least one different dimension that varies from about 0.5% to about 40% of said uncured tire-curing bladder, wherein the dimensions of the uncured tire-curing bladder are smaller than the subsequent uncured tire-curing bladder.

19. The method of claim 16, wherein the outer-surface curing mold is configured for compatibility with a tire-curing press.

20. The method of claim 16, wherein the outer-surface curing mold is a tire curing mold.

21. The method of claim 20, wherein the cured tire-curing bladder is used to cure a tire in a tire curing mold that fits in a tire curing press.

22. The method of claim 19, wherein the cured tire-curing bladder is used to cure a tire in a tire-curing mold that corresponds to the dimensions of the outer-surface curing mold.

23. The method of claim 16, further comprising curing a green tire with the cured tire-curing bladder and a tire-curing mold, the tire-curing mold having cross-sectional axial and radial dimensions of X and Y, and the outer surface curing mold having cross-sectional axial and radial dimensions of 0.6X to X and 0.6Y to Y.

24. The method of claim 16, wherein the outer-surface curing mold is a mold corresponding to the dimensions of a low-profile tire.

25. The method of claim 16, further comprising building the uncured tire-curing bladder on a drum.

26. The method of claim 25, further comprising adding a reinforcing layer to a rubber layer on the drum.

27. The method of claim 16, wherein the bladder-curing bladder, upon inflation, forces the outer surface of the uncured tire-curing bladder into contact with the outer-surface curing mold.

28. The method of claim 16, wherein the outer-surface curing mold includes one or more recessed grooves.

29. The method of claim 16, wherein a mold-release coating is present on the uncured tire-curing bladder, the bladder-curing bladder, or both.

30. The method of claim 16, wherein the tire-curing bladder has a thickness of less than 4.5 mm.

31. A tire-curing bladder comprising an organic rubber layer, and excluding a silicone rubber layer, the tire-curing bladder having a thickness of about 1 to less than 2.5 mm.

32. The tire-curing bladder of claim 31 comprising a reinforcing layer.

33. The tire-curing bladder of claim 31, wherein the thickness of about 1 to less than about 2.5 mm is at the center of the tire-curing bladder.

34. The tire-curing bladder of claim 31, the organic rubber layer comprising: butyl rubber, a halobutyl rubber, a modified butyl rubber, an ethylene propylene rubber, an ethylene propylene diene rubber (EPDM), a nitrile butadiene rubber, a hydrogenated nitrile butadiene rubber, a styrene butadiene rubber, a chloroprene rubber, an isoprene rubber, an epichlorohydrin rubber, an acrylic rubber, a chlorosulfonated polyethylene, or a fluorocarbon rubber.

35. A curing apparatus, comprising:
a press operable to heat an outer surface mold;
an outer surface mold coupled to the press comprising a plurality of rings defining a recess;
a first foot area recess defined in one or more rings configured to receive a foot area of a tire-curing bladder;
a second foot area recess defined in one or more rings configured to receive a foot area of a bladder-curing bladder.
